(19) United States
(12) Patent Application Publication
(10) Pub. No.: US 2002/0178946 A1
(43) Pub. Date: Dec. 5, 2002

(54) Cylinder of a rotary printing machine

(76) Inventor: Oliver Frank Hahn, Veitshochheim (DE)

Correspondence Address: Douglas R Hanscom, Jones Tullar & Cooper, PO Box 2266 Eads Station, Arlington, VA, 22202, US

(21) Appl. No.: 10/148,881

(22) PCT Filed: Dec. 2, 2000
(86) PCT No.: PCT/DE00/04291

(30) Foreign Application Priority Data
Dec. 21, 1999 (DE) 19961574.8

(51) Int. Cl. B41F 13/10

(52) U.S. Cl. 101/375

(57) ABSTRACT

The invention relates to the cylinder of a rotary printing machine in which cylinder two channels are arranged off-set from each other by an angle φ, said angle φ being determined depending on the moment of flexion f_{rib} inherent to the cylinder.

The invention relates to a cylinder of a rotary printing press in accordance with the preamble of claim 1.

DE 198 03 809 A1 and JP 10-071694A disclose transfer cylinders of a printing press with channels which are arranged offset by 180°.

The object of the invention is based on creating a cylinder.

In accordance with the invention, this object is attained by means of the characteristics of claim 1.

The advantages which can be achieved by means of the invention primarily lie in that the amplitude is minimized by passive vibration damping.

An exemplary embodiment of the invention is represented in the drawings and will be described in greater detail in what follows.

Shown are in:

FIG. 1, a cylinder performing printing, having a split channel with channel halves which are offset by an angle φ,

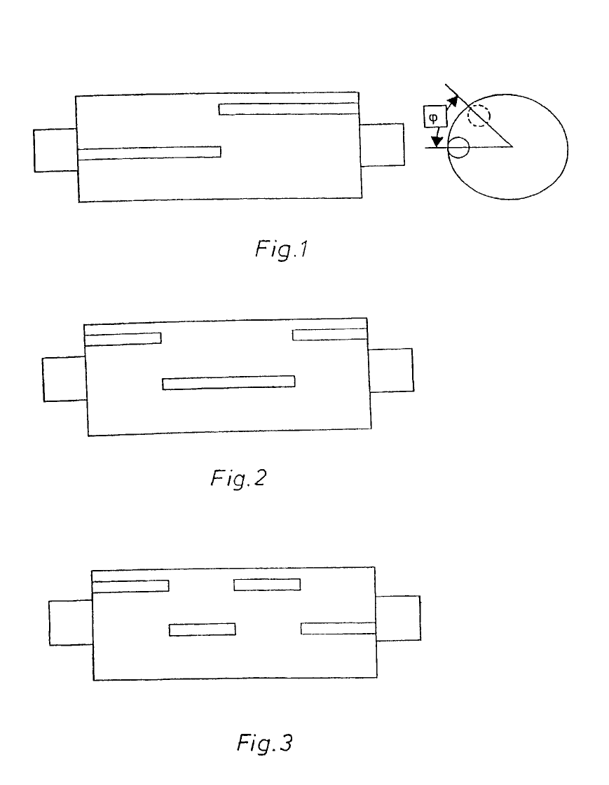

FIG. 2, a cylinder performing printing, having three channels offset by an angle φ,

FIG. 3, a cylinder performing printing, having four channels offset by an angle φ,

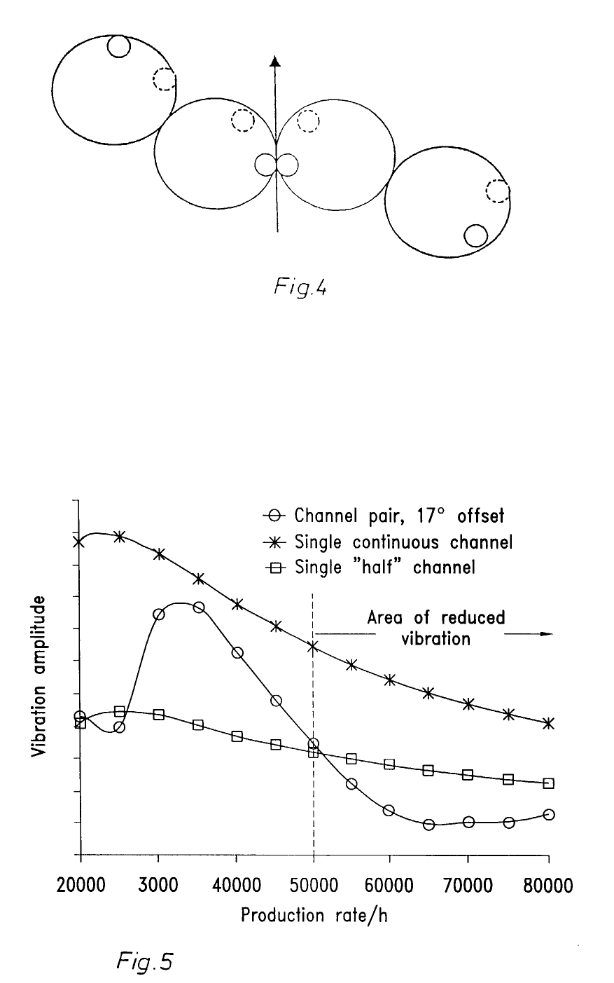

FIG. 4, an arrangement of channels in cylinders of equal circumference performing printing,

FIG. 5, vibration amplitudes after overrolling the pair of channels (FIG. 1) in comparison to overrolling a single continuous channel, or one extending over half the barrel width. The amplitudes relate to an “isolated” overrolling, i.e. an amplitude amplification by previous, not terminated overrolling is not taken into consideration.

The amplitude of the resultant total vibration within a definable rate of production range is minimized by the destructive interference of the vibration excited by sequential channel impacts. For this purpose the destructively interfering channel impacts must follow each other closely in order to best meet the interference conditions in regard to amplitude and phase relationships, for

(a) comparable amplitudes, i.e. the lowest possible vibration damping between the interfering channel impacts, lead to the greatest possible obliteration,

(b) the phase relationship, i.e. the chronological distance between the interfering channel impacts should vary as little as possible with the production rates in order to receive the obliteration over a wide range of production rates.

As represented in FIG. 1 to 3, each cylinder performing printing has split channels.

The channels of each cylinder are offset from each other by a defined angle φ.

The angle of offset φ derived from the inherent bending frequency f_{vib} of the cylinder and the rotation frequency fᵣₒₜ, at which the amplitude should be minimal, is calculated as

φ=(fᵣₒₜ/f_{vib})*180°

In the course of the structural conversion, a deviation of up to ±20% from the angle φ calculated in this way is permitted.

The channels of adjoining printing cylinders of equal circumference are arranged in such a way that the respective channels roll off on each other (FIG. 4).

The channels of adjoining printing cylinders, wherein a cylinder of double circumference is arranged next to a cylinder of single circumference, are arranged in such a way that the channels roll off on each other during every, or every second, revolution of the cylinder of single circumference.

Efficiency of the Vibration Damping:

In what follows, the channels represented in FIG. 1 and offset by the angle φ calculated in accordance with the above equation are called a “channel pair”. The resultant vibration amplitude after the channel pair has been rolled over, compared with the roll-over of a single channel extending over the entire barrel width, as well as in comparison with the roll-over of a single channel extending over half the barrel width, is shown by way of example in FIG. 5 in connection with an angle φ, which is optimized for the production rate of 70,000 pieces, for example newspaper pages, per hour.

The vibration-technological advantages of a cylinder performing printing and having a channel pair, over cylinders performing printing with divided channels, offset by a different angle (mostly 90° or 180°) (called in what follows “conventionally staggered”) are twofold:

(1) Following the roll-over of the channel pair, the vibration amplitude because of the destructive interference is lower by up to 60% than the one after the roll-over of a single split channel (FIG. 5).

(2) Following the roll-over of the channel pair, the excited vibration has available the entire cylinder rotation time 1/fᵣₒₜ for decay while, with conventionally staggered cylinders, another channel impact occurs within the same time. This is of importance in connection with high production rates in particular, wherein an amplitude amplification because of the superimposition of non-decayed vibrations takes place.

The cooperation of both effects increases the efficiency of the vibration damping past the amount represented in FIG. 5.

Comparison of the Structural Designs in FIGS. 1 to 3:

The first harmonic vibration of the bending vibration adds substantially to the total vibration amplitude after roll-over of the channel pair. Because the force introduction of the structural design in accordance with FIG. 2—in contrast to the embodiments in accordance with FIG. 1 and FIG. 3—does not have the symmetry of the first harmonic vibration, the latter is much less excited in the embodiment in accordance with FIG. 2. Opposed to this is the disadvantage of the embodiment in accordance with FIG. 2 that one channel impact takes place “on the outside”, and the other “on the inside”. This generally causes an excitation of varying strength of the base vibration, and therefore a reduction of the vibration damping by destructive interference.

Moreover, the embodiment of FIG. 1 should be favored over the embodiments in accordance with FIG. 2 and FIG. 3 in view of the possibilities of panoramic printing, as well as the simplicity of introducing the mechanical clamping channel elements.

As a whole, the embodiment in accordance with FIG. 1 thus represents the most favorable realization variation.

The cylinder is preferably designed as a forme or transfer cylinder with channels for fastening printing plates or rubber blankets.

1. A cylinder of a rotary printing press, having at least two channels which are offset in respect to each other at an angle φ in the circumferential direction, characterized in that the angle φ is determined as a function of the inherent bending frequency f_{vib} of the cylinder.

2. The cylinder in accordance with claim 1, characterized in that the angle φ is determined as a function of the rotation frequency fᵣₒₜ of the cylinder.

3. The cylinder in accordance with claims 1 and 2, characterized in that the angle φ has the dependence
1.2*(fᵣₒₜ/f_{vib})*180°≧angle φ≧0.8*(fᵣₒₜ/f_{vib})*180°.

4. The cylinder in accordance with claim 1, characterized in that the angle φ has the dependence
Angle φ=(fᵣₒₜ/f_{vib})*180°.

5. The cylinder in accordance with claim 1, characterized in that the selected rotation frequency fᵣₒₜ is laid out for the minimum vibration amplitude.

6. The cylinder in accordance with claim 1, characterized in that the cylinder is embodied as a forme or transfer cylinder.
